(19) United States
(12) Patent Application Publication
(10) Pub. No.: US 2006/0266599 A1
(43) Pub. Date: Nov. 30, 2006

(54) Control of brake noise by tuned mass dampers

(76) Inventors: Eric Denys, Ann Arbor, MI (US); Ahid Nashif, Cincinnati, OH (US)

Correspondence Address: QUINN LAW GROUP, PLLC, 39555 ORCHARD HILL PLACE, SUITE # 520, NOVI, MI, 48375, US

(21) Appl. No.: 11/137,945

(22) Filed: May 26, 2005

(51) Int. Cl. F16D 65/38

(52) U.S. Cl. 188/73.37

(57) ABSTRACT

This invention relates to the braking system of a vehicle and a method to attenuate noise-producing vibrations of components of the braking system by the use of tuned mass dampers of various designs mounted with respect to the brake pads and/or damper plate of a disc brake system. In another embodiment, the tuned mass dampers are attached to the brake shoes and/or drum brake backplate of a drum brake system.

### TECHNICAL FIELD

This invention relates to the braking system of a vehicle and a method to attenuate noise by the use of tuned mass dampers mounted in relation to the brake pads, brake shoes, and/or drum brake backplate.

### BACKGROUND OF THE INVENTION

Modern automotive braking systems may be grouped into two basic categories, disc brakes and drum brakes. Of the two systems, disc brakes offer higher performance, simpler design, lighter weight, self-adjustability, and better resistance to water interference. Drum brakes have a greater number of parts than disc brakes and are therefore more difficult to service, but they are less expensive to manufacture, can easily incorporate an emergency brake system, and provide adequate braking force. For the foregoing reasons, manufacturers tend to favor the use of drum brakes at the rear wheels of most modern automobiles.

When a forward-moving vehicle brakes, the pitching motion of the vehicle creates a dynamic shift in the vehicle weight toward the front wheels. Therefore, it is necessary to have a highly effective braking system located at the front wheels of the vehicle. Accordingly, many of vehicles produced today have disc brakes on the front wheels and drum brakes at the rear wheels. Almost certainly, for as long as there have been braking systems in general use, there have been objectionable noises produced by these systems that engineers have attempted to eliminate.

The main components of a disc brake system are the rotor (A.K.A disc), caliper, piston, and pad. The brake pad has a frictional lining supported by a rigid backing plate. The caliper holds the brake pads in proximity to the rotor and has at least one integrally mounted piston. Upon activation of the braking system, the piston urges the pad against the brake rotor thereby creating the frictional force necessary to slow the vehicle. Disc brake systems can further be subdivided into two subgroups, the floating-type caliper and the fixed-type caliper. The floating-type caliper contains at least one piston that presses the brake pad firmly against the rotor upon activation of the braking system. This movement creates a reaction force that causes the caliper to slide on pins thereby bringing the second brake pad into contact with the brake rotor. The fixed caliper design contains at least two pistons, one on each side of the rotor, each of which urges their respective brake pads into contact with the brake rotor while the caliper remains in a fixed position. The floating caliper system is the most widely used system on modern vehicles due to their lower cost and higher reliability relative to that of fixed calipers.

Both fixed and floating caliper disc brake systems may suffer from an objectionable noise termed “brake squeal” when a braking force is applied. This condition, especially at high frequencies, occurs whenever two or more of the brake components match in their dynamic behavior and couple together as a new system. In most cases, the brake pad resonances match with those of the brake rotor both in frequency and in wavelength. As a result, the brake pad will begin to vibrate in-phase with the rotor as a new system with very little damping. If the level of damping in the new system is lower than necessary to dissipate the input energy from the friction forces during braking, the amplitude of vibration of the new system will increase until the system becomes unstable leading to “brake squeal”. Therefore, by increasing the damping in the newly coupled system, the system can be maintained in a stable condition since it can dissipate more energy than is being introduced from the frictional forces. Since both the rotor and pad are vibrating together in-phase, the addition of damping to either component will tend to damp the system. However, due to the high temperature of the rotor in operation, many of the applications have been limited to adding damping to the pad.

Many inventors have attempted to alleviate the noise problem that may be encountered with disc brakes.

U.S. Pat. No. 5,660,251 issued to Nishizawa et al. on Aug. 26, 1997, discloses a disc brake damping mechanism that detects vibrations of the brake rotor by a piezoelectric element pressed against the backing plate of one on the brake pads. The detection signal is input to a control circuit, which then applies a control signal to another piezoelectric element that produces oscillations having a frequency operable to reduce the detection signal to zero. This active damping system may be more costly to implement than that of a passive system, and may not be economically viable for large-scale use on commercially produced vehicles.

U.S. Pat. No. 5,099,962 issued to Furusu et al. on Mar. 31, 1992, discloses a disc brake backing plate with two layers of viscoelastic material disposed between three metal plates forming a constrained layer viscoelastic laminate. Although constrained layer damping treatments have been found to be effective, in most cases there is still a need to introduce additional damping to the system. Because of the spatial limitations of the disc brake system, this cannot be done with thicker constrained treatments.

The present invention may also be applied to a drum brake assembly. The drum brake system has changed little since it was first incorporated on vehicles. Drum brake systems tend to produce the same “brake squeal” that disc brakes produce.

A brief description of the operation of a drum brake system may help to understand the problem that is to be solved by the present invention. The typical drum brake system has many movable parts that must work in concert to effect a vehicle stop. In a typical drum brake assembly there is a backplate that mounts to the axle in a rear mounted configuration. Attached to this backplate is a hydraulic wheel cylinder that houses two internal pistons. These pistons move oppositely outward from the center of the wheel cylinder when the vehicle brake pedal is depressed which, in turn, force metal rods to act upon the brake shoes that are movably mounted with respect to the backplate. The brake shoes are allowed to pivot at the end opposite the wheel cylinder. This pivot point in modern drum brakes is typically defined by what is called a “star wheel” adjuster that allows brake adjustment to compensate for brake wear. The brake shoes consist of a friction element, often referred to as a liner, and a rim to which the liner is attached. A plate, commonly referred to as the web, is oriented perpendicularly to the rim of the shoe. The web provides structural support to the brake shoe to prevent shoe collapse under severe braking. When force is applied to the brake shoe by the wheel cylinder, the shoes are forced outward to frictionally engage the cylindrical surface defined by the inside diameter of the brake drum. This frictional engagement provides the necessary braking force to slow the vehicle. The operation of a drum brake system may result in noise producing vibrations of the brake shoes, which may subsequently radiate to other elements of the drum brake system This is an undesirable phenomenon since these vibrations may result in the production of “brake squeal” that may be further amplified by the backplate of the drum brake system. This backplate may act as a soundboard and cause a marginal “brake squeal” to become unacceptable.

Other inventors have attempted to alleviate the noise problem that may be encountered with drum brakes.

U.S. Pat. No. 5,099,967 issued to Lang on Mar. 31, 1992, discloses a drum brake assembly that utilizes a layer of viscoelastic damping material sandwiched between two metal plates and mounted by various techniques to what the inventor refers to as the abutment. This device may serve to damp the vibrations of the brake shoe, however modern brakes typically employ a “star wheel” adjuster in place of the abutment, thereby making the device difficult to implement in certain drum brake systems.

### SUMMARY OF THE INVENTION

Accordingly, the present invention damps the noise producing vibrations of a disc brake pad by affixing to the brake pad and/or damping plate a tuned mass damper (TMD) of various configurations. The present invention can also damp the noise producing vibrations of a drum brake shoe and drum brake backplate by mounting a tuned mass damper to one or both of the aforementioned drum brake components.

In most “brake squeal” conditions, it is one or more of the first three bending modes of vibration of the pad that couple with those of the rotor in the case of a disc brake, or the shoe and the drum in the case of a drum brake. Therefore, it is necessary to consider tuned mass dampers that can be added directly to the brake pad or brake shoe to handle one or all of the modes of vibration over the operating temperature and pressure range.

One embodiment of the present invention includes mounting at least one “viscoelastic type” tuned mass damper to the disc brake pad backing plate. The “viscoelastic type” tuned mass damper is typically constructed by affixing a mass to a viscoelastic layer. This “viscoelastic type” tuned mass damper may be mounted on the face of the backplate opposite the frictional liner. With this placement, the “viscoelastic type” tuned mass damper would tend to operate in a tension-compression mode.

Another embodiment of the present invention is to mount the “viscoelastic type” tuned mass damper to the edge or periphery of the brake pad backing plate. This orientation will force the “viscoelastic type” tuned mass damper to operate in shear.

The “viscoelastic type” tuned mass damper may be affixed to the rim and/or the web of the drum brake shoe. This placement will cause the “viscoelastic type” tuned mass damper to operate in a tension-compression or shear depending on the type of vibration experienced by the rim and web of the brake shoe.

Yet another embodiment of the present invention is a “dual mode” tuned mass damper mounted on any of the components or in any orientation previously described in reference to the “viscoelastic type” tuned mass damper.

The “dual mode” tuned mass damper has secondary mass and viscoelastic layer affixed atop a primary mass and viscoelastic layer. The type of materials and geometries for the “dual mode” tuned mass damper is application dependant. However, to be effective, the viscoelastic element with the highest modulus should be placed on the bottom of the stack, closest to the surface of the host structure. “Dual mode” tuned mass dampers increase the effectiveness of operation over a temperature range while attenuating more than one resonant frequency of the host structure.

Yet another embodiment of the present invention includes incorporating a “beam type” tuned mass damper into the braking system of a vehicle. The “beam type” tuned mass damper has an infinite number of natural frequencies, with each natural frequency corresponding to one of the bending modes of the beam. However, the effectiveness of the “beam type” tuned mass damper will diminish at the higher resonant frequencies due to a decrease in modal mass with higher order bending modes. The “beam type” tuned mass damper may be affixed to the brake pad backing plate or the damping plate commonly found in disc brake systems.

Additionally, a “beam type” tuned mass damper may be formed from the damping plate by leaving a portion of the damping plate unbonded to the brake pad backing plate. This “beam type” tuned mass damper will operate as a beam clamped at each end.

The “beam type” tuned mass damper may also be affixed to the web or rim of the drum brake shoe as well as the backplate of the drum brake system. The beam of the “beam type” tuned mass damper will operate to damp the vibrations of the brake pad, brake shoe, and/or backplate.

Preferably, these beams will be of a material with sufficient stiffness and mass to provide the necessary resonant frequency to the system such as steel, aluminum, magnesium, composite, etc. The beam may be formed from a constrained layer viscoelastic laminate material to increase the damping capability of the tuned mass damper. This laminate may include at least one viscoelastic layer disposed between at least two constraining layers. The constraining layers may be made of any material capable of providing the necessary stiffness to the viscoelastic layer such as, steel, magnesium, aluminum, composites, etc. A plurality of “beam type” tuned mass dampers of varying geometrical and material properties may be provided to facilitate the damping of multiple frequencies. The beam may be of any shape providing that the proper resonant frequency of the beam is maintained. A secondary mass or masses may be applied along the beam in order to increase the modal mass of the tuned mass damper.

Any of the previously mentioned tuned mass dampers may be used separately from, or in conjunction with, each other to achieve the desired level of vibration damping within the braking system. The preferred placement of the tuned mass damper will be the point of maximum amplitude of vibration, which is the position where the tuned mass damper is most effective.

Accordingly, the present invention provides a brake system for a vehicle having a first and a second selectively engageable brake member, wherein at least one of the first and the second brake members is movable with respect to the other brake member when at least one of the brake members is engaged. Also provided is a third brake member rotatable with respect to the first and second brake members, wherein at least one of the first and second brake members is operable to frictionally engage the third brake member. At least one of the first and second brake members will have at least one tuned mass damper affixed thereto and operable to damp vibrations in at least one of the first and second brake members when the first and second brake members frictionally engage the third brake member. The tuned mass damper will have a placement substantially at a point of maximum amplitude for a given mode of vibration of the first and second brake member to which the tuned mass damper is attached.

The tuned mass damper may consist of a mass affixed to a viscoelastic element. This type of tuned mass damper may be mounted with respect to a face of a disc brake pad backing plate or may be mounted with respect to a perimeter edge of the brake pad backing plate. This type of tuned mass damper may also be mounted with respect to the rim and/or web of the drum brake shoe. The tuned mass damper may also have a secondary tuned mass damper affixed to the first tuned mass damper and thereby creating a “dual mode” tuned mass damper. The “dual mode” tuned mass damper may also be mounted with respect to the brake pad backing plate. The “dual mode” tuned mass damper may also be mounted with respect to the web or rim of the drum brake shoe.

The tuned mass damper may also be a beam mounted on at least one of the first and second brake members and operable to damp the vibrational kinetic energy occasioned by at least one of the first and second brake members. The beam may also have a secondary mass affixed at any point along the beam to increase the modal mass of the tuned mass damper.

The tuned mass damper may also be a beam formed from a constrained layer viscoelastic laminate material having at least two constraining layers, and at least one viscoelastic core disposed therebetween. This “beam type” tuned mass damper may be affixed to at least one of the first and second brake members and is operable to damp the vibrational kinetic energy occasioned by the brake member upon which it is mounted. The beam may also have a secondary mass affixed at any point along the beam to increase the modal mass of the tuned mass damper.

The present invention also provides a disc brake system having a caliper and at least one piston contained within a cylinder formed integrally within the caliper and in fluid communication with the brake system. The disc brake system also has a first brake pad mounted with respect to the piston and having a first frictional lining and a first brake pad backing plate; and a second brake pad having a second frictional lining and a second brake pad backing plate. Also provided is at least one damping plate mounted with respect to at least one of the second brake pad backing plate and the first brake pad backing plate.

The damping plate of the present invention may have at least one energy dissipating beam extending therefrom and operable to cancel the kinetic energy occasioned by the vibration of the first or second brake pads. This energy dissipating beam may be made from a constrained layer viscoelastic laminate material having at least two constraining layers and at least one viscoelastic layer disposed therebetween. Additionally, a beam may be made by not bonding an area of the damping plate to the brake pad backing plate.

The present invention also provides a drum brake assembly having at least one brake shoe, a drum brake backplate mounted with respect to the shoe, and at least one tuned mass damper mounted with respect to the drum brake backplate and operable to damp vibrations occasioned by the backplate. The at least on tuned mass damper will be placed substantially at a point of maximum amplitude for a given mode of vibration of said backplate. The tuned mass damper may be of a “dual mode” design wherein a first tuned mass damper having a primary viscoelastic element and a primary mass and a second tuned mass damper mounted with respect to the first tuned mass damper and having a secondary mass affixed to a secondary viscoelastic element. The tuned mass damper may also be a beam mounted to the backplate operable to damp the vibrational kinetic energy occasioned by the backplate. The tuned mass damper may also be a beam formed from a constrained layer viscoelastic laminate material having at least two constraining layers and at least one viscoelastic layer disposed therebetween, and mounted to the drum brake backplate operable to damp the kinetic energy occasioned by the backplate.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a front schematic sectional view of a typical fixed caliper disc brake system illustrating pad engagement with the rotor;

FIG. 2 is a perspective view of a typical disc brake pad illustrating possible placements of a “viscoelastic type” tuned mass damper;

FIG. 3 is a schematic perspective view of a “dual mode” tuned mass damper formed from a secondary mass affixed to a secondary viscoelastic element which in turn is affixed to a primary “viscoelastic type” tuned mass damper;

FIG. 4 is a perspective view of a typical disc brake pad illustrating a “beam type” tuned mass damper and possible placements;

FIG. 5 is a perspective view of a typical disc brake pad illustrating the “beam type” tuned mass dampers as an integral portion of the damper plate as well as possible placements;

FIG. 6 is a schematic sectional view of a “beam type” tuned mass damper formed from a constrained layer viscoelastic laminate;

FIG. 7 is a bottom sectional view of a typical drum brake system illustrating shoe engagement with the brake drum;

FIG. 8 is a perspective view of a typical drum brake shoe illustrating possible placements of a “viscoelastic type” tuned mass damper;

FIG. 9 is a perspective view of a typical drum brake shoe illustrating a “beam type” tuned mass damper and possible placements; and

FIG. 10 is a front view of a typical drum brake backplate illustrating possible placements of various types of tuned mass dampers.

### DESCRIPTION OF THE PREFERRED EMBODIMENTS

The following description of the preferred embodiments should not be construed to limit the invention. For purposes of clarity, the same reference numbers will be used within the several figures to identify similar elements.

The present invention damps the noise producing vibrations of a disc brake pad by affixing to the backing plate of the brake pad or the damping plate a tuned mass damper (TMD) of various configurations. The present invention can also damp the noise producing vibrations of a drum brake shoe and drum brake backplate by mounting a tuned mass damper to one or both of the aforementioned drum brake components.

In its basic form, a tuned mass damper consists of a mass on a spring. The mass and stiffness of the spring are chosen so that they will have a resonance at a desired frequency. Applying such a system to a vibrating host structure having the same or slightly higher resonant frequency will cause the mass of the damper to move 180 degrees out-of-phase with the host structure and, thereby, reduce its amplitude of vibration at the critical frequency. If the spring has little damping, as in metal springs, the effectiveness of the tuned mass damper is limited. Thus, using materials with good damping capabilities will increase the damping effectiveness of the tuned mass damper.

Tuned mass dampers are typically constructed from a combination of viscoelastic material and a mass such as steel or lead. The viscoelastic material acts as a spring as well as providing, a measure of damping to the system, while the mass increases the energy that can be absorbed by the tuned mass damper. The mass and the spring rate of the viscoelastic material determine the resonant frequency of the system. The system is tuned to this frequency. The selection of the material properties and the viscoelastic material are important considerations that are highly application dependent.

In its elemental form, the tuned mass damper consists of a mass, spring, and a dashpot. The spring and dashpot are connected in parallel to the mass. A tuned mass damper is a single degree of freedom resonant system. When mounted to a rigid base, the properties of the tuned mass damper can be characterized by the following equations:

$$Natural Frequency = \frac{1}{2 π} \sqrt{k / m}$$

where (k) is the spring stiffness and (m) is the mass

$$Damping Ratio = \frac{c}{( 2 * \sqrt{k m} )}$$

where (k) is the spring stiffness and (m) is the mass and (c) is the damping coefficient

The spring stiffness (k) and mass (m) of the tuned mass damper should be chosen in order to place the natural frequency of the tuned mass damper approximately equal to or slightly less than the mode to be damped in the host structure. This so-called “target” mode of the host structure is thusly replaced by two modes, with one mode slightly below and one mode slightly above the original resonant mode of the host structure. These “split modes” are then attenuated by the damping element of the tuned mass damper. In effect, the tuned mass damper converts the vibrational energy of the target mode of the host structure into heat.

The damping effectiveness of the tuned mass damper is highly dependent on the damping ratio. A damping ratio of 20 to 30 is an effective range for a tuned mass damper. Preferably, the tuned mass dampers are placed substantially at points on the host structure where the amplitude of oscillation is greatest for the given mode of vibration. With this placement, the tuned mass damper will be much more effective at vibration attenuation compared to tuned mass dampers placed elsewhere on the vibrating body. The point of the greatest amplitude of oscillation may be determined analytically through computer modeling using finite element techniques or directly through experimentation using devices such as accelerometers or laser vibrometers.

Many structures have more than one resonant condition, which creates the need for multiple mode dampers. The simplest way to have a multiple mode damper is to have several spring mass systems combined together to create several resonant frequencies. An alternate way to damp multiple resonances of a structure is to consider other systems that can have several resonant frequencies such as beams. The advantage of using these systems is that they have more than one resonant frequency, making them ideal to attenuate more than one resonant frequency of the host structure.

In most “brake squeal” conditions, it is one or more of the first three bending modes of vibration of the pad that couple with those of the rotor in the case of a disc brake, or the shoe and the drum in the case of a drum brake. Therefore, it is necessary to consider tuned mass dampers that can be added directly to the brake pad or brake shoe to handle one or all of the modes of vibration over the operating temperature and pressure range. In addition, it may be beneficial to affix the tuned mass damper to the a drum brake backplate to further attenuate any additional noise producing vibrations.

An important parameter to consider when designing a damped brake system is the total mass of the tuned mass damper. There must be sufficient “modal mass” of the tuned mass damper, relative to the mass of the host structure to which the tuned mass damper is attached in order to realize the desired tuning effect. A rule for tuned mass damper tuning is that the modal mass of the tuned mass damper should be approximately 10% of the modal mass of the host structure. By affixing the tuned mass damper directly to the brake pad or brake shoe instead of heavier components, such as the caliper or wheel cylinder, the mass of the tuned mass damper can be reduced. In the preferred embodiment, the tuned mass damper of the present invention will weigh 10 grams or less.

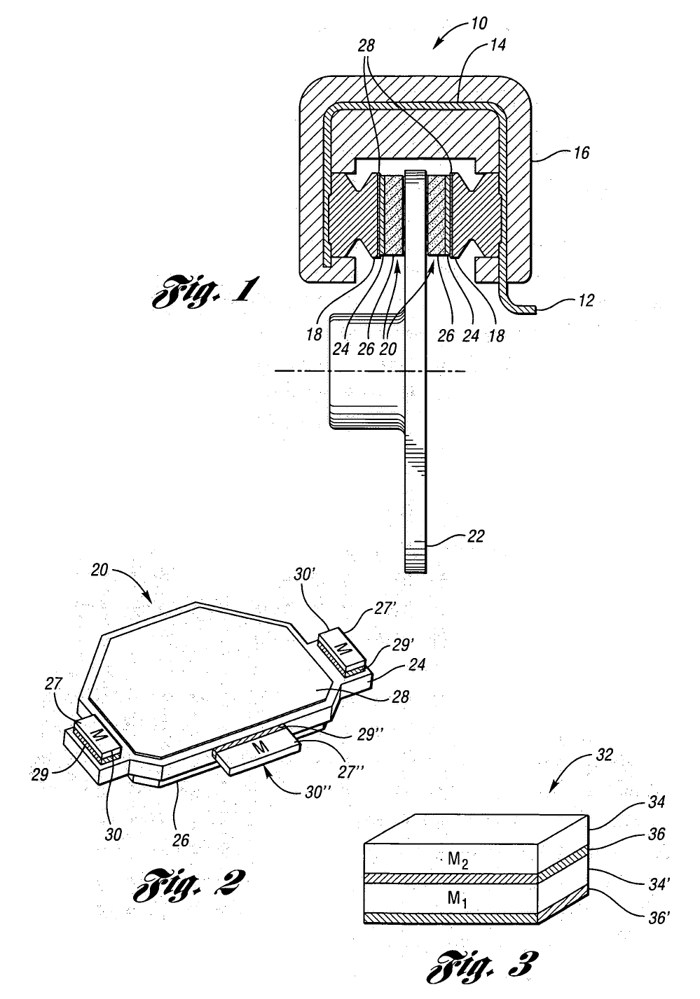

FIG. 1 is a front schematic sectional view of a typical disc brake system 10. The disc brake system 10 illustrated is of a fixed caliper design. However, the present invention may be applied to a sliding caliper system while maintaining the inventive concept. In operation, fluid within the hydraulic line 12 will pressurize the hydraulic cavities 14 contained within the caliper 16. This in turn forces the pistons 18 on each respective side of the caliper 16 to urge the brake pads 20 against the brake rotor 22. The brake pads 20 are characterized by a brake pad backing plate 24 and a frictional liner 26. The frictional liner 26 is the element of the brake pad 20 that contacts the brake rotor 22 providing the frictional force necessary to slow the vehicle. This frictional engagement may lead to vibrations of the brake pad 20, a phenomenon that may cause an objectionable noise to be emitted by the disc brake system 10. Engineers have attempted to attenuate this noise by placing a damping plate 28 between the piston 18 and the brake pad backing plate 24. This treatment may not completely attenuate the noise causing vibrations of the brake pad 20. The hydraulic disc brake system 10 is exemplary only, and is not meant to limit the scope of the present invention. Those skilled in the art will realize that the disc brake system 10 may be actuated in other ways including pneumatic, mechanical, and electromechanical actuation.

FIG. 2 is a perspective view of a brake pad 20 illustrating possible placements of a tuned mass damper 30 formed from a mass (M) 27 affixed to a viscoelastic element 29. This “viscoelastic type” tuned mass damper 30 may be mounted on one face of the brake pad backing plate 24 as shown by the “viscoelastic type” tuned mass dampers 30 and 30′. The orientation of the “viscoelastic-type” tuned mass dampers 30, 30′ will cause the viscoelastic elements 29 and 29′, affixed to the masses 27 and 27′, to operate in a tension-compression mode. However, there due to spatial limitations, a perimeter edge mounted orientation may be preferred. The “viscoelastic type” tuned mass damper 30″ illustrates the perimeter edge mounted orientation. This orientation will cause the viscoelastic element 29″, affixed to the mass 27″, to operate in shear.

FIG. 3 illustrates a “dual mode” tuned mass damper 32 formed from a secondary mass (M₂) 34 affixed to a secondary viscoelastic element 36 which in turn is affixed to a primary mass (M₁) 34′ affixed to a primary viscoelastic element 36′. The proper selection of the type of materials and geometries of the “dual mode” tuned mass damper 32 is critical for its effectiveness and is highly application dependant. However, for proper performance, the primary viscoelastic element 36′ should have the highest modulus of the two viscoelastic elements 36 and 36′, and should be placed on the bottom of the stack, closest to the surface of the brake pad backing plate 24 shown in FIG. 2. The “dual mode” tuned mass damper 32 may be placed in the same orientations as the viscoelastic tuned mass dampers 30, 30′, and 30″. The “dual mode” tuned mass damper may increase the effectiveness of operation over a temperature range while attenuating more than one resonance of the pad.

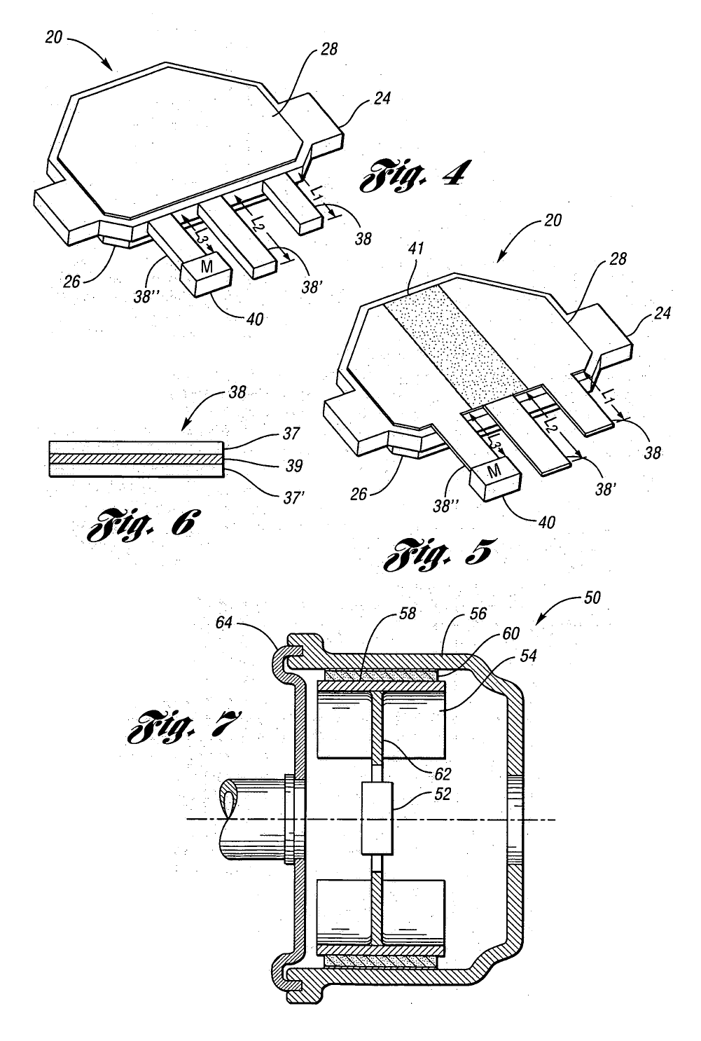

FIG. 4 is a perspective view of a disc brake pad illustrating a “beam type” tuned mass damper 38 and possible placements. In this embodiment, the “beam type” tuned mass dampers 38, 38′, and 38″ are mounted directly to the brake pad backing plate 24 and should extend sufficiently therefrom to damp the vibrations of the brake pad 20. Preferably, these “beam type” tuned mass damper 38, 38′, 38″ will be of a material with sufficient stiffness to provide the necessary resonant frequency to the system such as steel, magnesium, aluminum, composites, etc.

To increase the damping capability of the “beam type” tuned mass damper 38, the beam may be formed from a constrained layer viscoelastic laminate material, as shown in FIG. 6. This laminate may include at least one viscoelastic layer 39 disposed between at least two constraining layers 37 and 37′. The constraining layers 37 and 37′ may be made of any material capable of providing the necessary stiffness to the viscoelastic core such as, steel, magnesium, aluminum, composites, etc.

Referring back to FIG. 4, a plurality of beams of varying geometries and material properties may be provided to allow the damping of multiple frequencies as illustrated by a beam extending for a length L₁ and a second beam extending for a length L₂. The “beam type” tuned mass damper 38 may be of any shape providing that the proper resonant frequency is maintained. A secondary mass 40 may be applied at any point along the beam to increase the modal mass of the tuned mass damper. As illustrated in FIG. 5, any of the above “beam type” tuned mass dampers 38 may be incorporated into the damping plate 28 commonly found in disc brake systems. Additionally, FIG. 5 shows an alternate type of “beam type” tuned mass damper 41, shown as the shaded area of the damping plate. The “beam type” tuned mass damper 41 is formed by not bonding this shaded area of the damping plate 28 to the brake pad backing plate 24. The “beam type” tuned mass damper 41 will operate as a beam clamped at each end. The shape and position of the non-bonded section that forms the “beam type” tuned mass damper 41 will vary as a function of the shape of the brake pad backing plate 24 and its vibration characteristics.

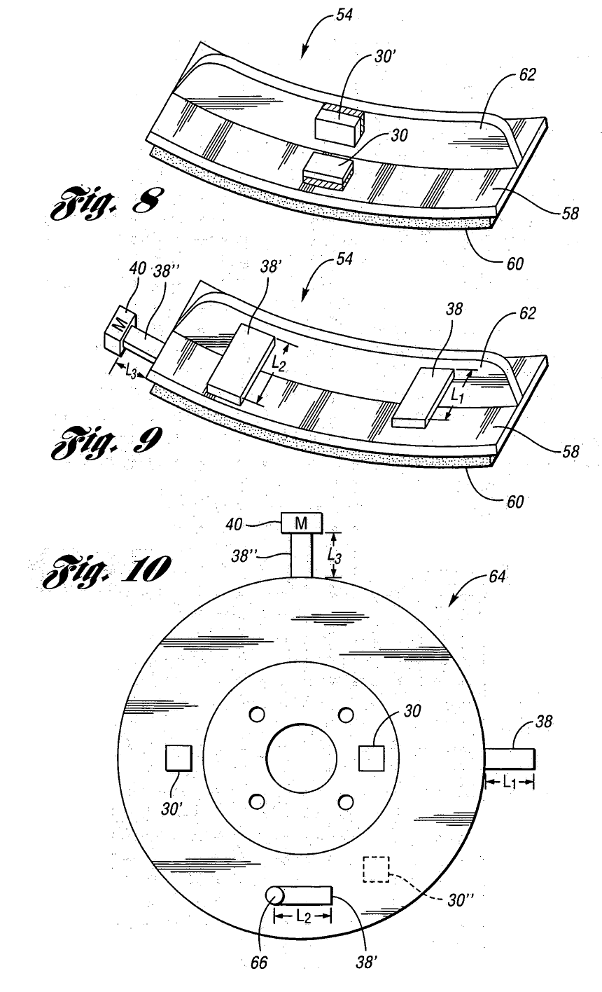

Additionally, the present invention may be applied to drum brakes. FIG. 7 is a bottom sectional view of a typical drum brake system 50. The drum brake system 50 is operated by hydraulically pressurizing the wheel cylinder 52 which in turn urges the brake shoes 54 against the cylindrical surface defined by the inside diameter of the rotating brake drum 56. The brake shoe 54 includes a rim 58 having a frictional liner 60 attached on one side, and an approximately perpendicular web 62 mounted to the rim 58 on the side opposite the liner 60. The web 62 protects the brake shoe 54 from collapse under severe braking. The liner 60 contacts the rotating brake drum 56 thereby creating the frictional force necessary to slow the vehicle. The hydraulic drum brake system 50 is exemplary only, and is not meant to limit the scope of the present invention. Those skilled in the art will realize that the drum brake system 50 may be actuated in other ways including pneumatic, mechanical, and electric actuation.

FIG. 8 is a perspective view of a drum brake shoe 54 illustrating possible placements of a “viscoelastic type” tuned mass damper 30. The “viscoelastic type” tuned mass damper 30 may be placed on the side of the rim 58 opposite the liner 60 of the brake shoe 54. An alternate placement would be to mount the “viscoelastic type” tuned mass damper 30′ on the web 62 of the brake shoe 54. The type of vibration mode experienced by the brake shoe 54 will determine whether the “viscoelastic type” tuned mass dampers 30 and 30′ will operate in shear, tension/compression, or a combination thereof. Additionally, the “dual mode” tuned mass damper 32 may be substituted for the previously described “viscoelastic type” tuned mass damper 30 to increase damping effectiveness.

FIG. 9 is a perspective view of a drum brake shoe 54 illustrating a “beam type” tuned mass damper 38 and possible placements. The “beam type” tuned mass damper 38 may be mounted to the rim 58 or the web 62 of the brake shoe 54. Preferably, these “beam type” tuned mass dampers 38 will be of a material with sufficient stiffness to provide the necessary resonant frequency to the system such as steel, aluminum, or a composite. To increase the damping effectiveness of the “beam type” tuned mass damper 38, the beam may be formed from a constrained layer viscoelastic laminate material, as shown in FIG. 6. This laminate may include at least one viscoelastic layer 39 disposed between at least two constraining layers 37 and 37′. The constraining layers 37 and 37′ may be made of any material capable of providing the necessary stiffness to the viscoelastic layer 39 such as, steel, magnesium, aluminum, composites, etc. A plurality of “beam type” tuned mass dampers 38 of varying geometries and material properties may be provided to increase the effectiveness of damping multiple frequencies. This is illustrated by a “beam type” tuned mass dampers 38 extending for a length L₁ and a second “beam type” tuned mass dampers 38′ extending for a length L₂. The “beam type” tuned mass damper 38 may be of any shape provided that the proper resonant frequency is maintained. A secondary mass 40 may be applied at any point along the beam in order to increase the modal mass of the “beam type” tuned mass dampers 38.

Additionally, it may be necessary to damp vibrations of the drum brake backplate 64, shown in FIG. 10. The drum brake backplate 64 is traditionally formed from a stamped piece of sheet metal, which may amplify the noise caused by the vibration of various components of the drum brake system 50. The drum brake backplate 64 may act as a soundboard and cause a marginal “brake squeal” to become unacceptable. Consequently, it may be beneficial to mount a “viscoelastic type” tuned mass damper 30, “dual mode” tuned mass damper 32, or a “beam type” tuned mass dampers 38 described previously to the drum brake backplate 64.

The “viscoelastic type” tuned mass damper 30 and 30′ may be mounted on the internal surface of the drum brake backplate 64. Alternately, the “viscoelastic type” tuned mass damper 30″ may be mounted on the external surface of the drum brake backplate 64. The “dual mode” tuned mass damper 32 may be substituted for the “viscoelastic type” tuned mass damper 30 for increased damping effectiveness.

The “beam type” tuned mass damper 38 may be mounted on the periphery of the drum brake backplate as illustrated by “beam type” tuned mass dampers 38 and 38″. Alternately, the “beam type” tuned mass damper 38′ may be mounted on the internal surface or the external surface by providing a mounting base 66 to fixedly attach the “beam type” tuned mass damper 38′ to the drum brake backplate 64. The mounting base 66 will serve to hold the “beam type” tuned mass damper away from the drum brake backplate 64 thereby allowing movement of the beam. The “beam type” tuned mass dampers may be solid, or constructed from a constrained layer viscoelastic laminate as shown in FIG. 6. A secondary mass 40 may be provided at any point along the “beam type” tuned mass dampers 38 to increase the modal mass of the “beam type” tuned mass damper 38. A plurality of “beam type” tuned mass dampers 38 of varying geometries and material properties may be provided to increase the damping effectiveness over multiple frequencies as illustrated by a “beam type” tuned mass dampers 38 extending for a length L₁ and a second “beam type” tuned mass dampers 38′ extending for a length L₂. The “beam type” tuned mass damper 38 may be of any shape providing that the proper resonant frequency of the “beam type” tuned mass dampers 38 is maintained.

Any of the previously mentioned tuned mass dampers 30, 32, or 38 may be used separately from, or in conjunction with, each other to achieve the desired level of brake damping. The preferred location of the tuned mass damper will be the point of maximum amplitude, which tends to be the position where the tuned mass damper is most effective.

While the best modes for carrying out the invention have been described in detail, those familiar with the art to which this invention relates will recognize various alternative designs and embodiments for practicing the invention within the scope of the appended claims.

1. A brake system for a vehicle comprising:
first and a second selectively engageable brake members, wherein at least one of said first and second brake members is movable with respect to the other of said first and second brake members;
a third brake member rotatable with respect to said first and second brake members, wherein said at least one of said first and second brake members is operable to frictionally engage said third brake member; and
wherein said at least one of said first and second brake members has at least one tuned mass damper attached thereto and operable to damp vibrations in said at least one of said first and second brake members when said at least one of said first and second brake members frictionally engage said third brake member, said at least one tuned mass damper being placed substantially at a point of maximum amplitude for a given mode of vibration of said at least one of said first and second brake member.

2. The brake system of claim 1, wherein said at least one tuned mass damper is comprised of a mass affixed to a viscoelastic element.

3. The brake system of claim 2, wherein said at least one of said first and second brake members is a brake pad comprising a frictional liner attached to a brake pad backing plate, said at least one tuned mass damper being mounted with respect to a face of said brake pad backing plate.

4. The brake system of claim 2, wherein said at least one of said first and second brake members is a brake pad comprising a frictional liner attached to a backing plate, said at least one tuned mass damper extending from a perimeter edge of said backing plate.

5. The brake system of claim 3, wherein said at least one tuned mass damper comprises a primary viscoelastic element and a primary mass, and the brake system further comprises a secondary tuned mass damper having a secondary mass affixed to a secondary viscoelastic element which in turn is affixed to said at least one tuned mass damper to form a dual mode tuned mass damper.

6. The brake system of claim 4, wherein said at least one tuned mass damper comprises a primary viscoelastic element and a primary mass, and the brake system further comprises a secondary tuned mass damper having a secondary mass affixed to a secondary viscoelastic element which in turn is affixed to said at least one tuned mass damper to form a dual mode tuned mass damper.

7. The brake system of claim 2, wherein said first and second brake members are brake shoes having a frictional liner attached to a rim, and an approximately perpendicular web mounted with respect to said rim, said at least one tuned mass damper being mounted with respect to at least one of said rim and said web.

8. The brake system of claim 7, wherein said at least one tuned mass damper comprises a primary viscoelastic element and a primary mass, and said brake system further comprises a secondary tuned mass damper having a secondary mass affixed to a secondary viscoelastic element which in turn is affixed to said at least one tuned mass damper to form a dual mode tuned mass damper.

9. The brake system of claim 1, wherein said at least one tuned mass damper comprises at least one beam affixed to at least one of said first and second brake members, said at least one beam being operable to damp the vibrational kinetic energy occasioned by at least one of said first and second brake members.

10. The brake system of claim 1, wherein said at least one tuned mass damper comprises at least one beam formed from a constrained layer viscoelastic laminate material, having at least two constraining layers and at least one viscoelastic layer disposed therebetween, and said at lease one beam being affixed to at least one of said first and second brake members, and operable to damp the vibrational kinetic energy occasioned by at least one of said first and second brake members.

11. The brake system of claim 9, further comprising a mass attached to said at least one beam to increase the modal mass of said tuned mass damper.

12. A disc brake system comprising:
a caliper;
at least one piston contained within a cylinder formed integrally with said caliper;
a first brake pad mounted with respect to said at least one piston and having a first frictional lining and a first brake pad backing plate;
a second brake pad having a second frictional lining and second brake pad backing plate; and
at least one damping plate mounted with respect to at least one of said first brake pad backing plate and said second brake pad backing plate, said at least one damping plate having at least one tuned mass damper operable to damp vibrations in the member to which said damping plate is attached.

13. The disc brake system of claim 12, wherein said at least one tuned mass damper is at least one energy dissipating beam operable to damp kinetic energy occasioned by the vibration of at least one of said first and said second brake pads.

14. The disc brake system of claim 13, wherein said at least one energy dissipating beam is made from a constrained layer viscoelastic laminate material comprising at least two constraining layers and at least one viscoelastic layer disposed therebetween.

15. The disc brake system of claim 13, wherein said at least one energy dissipating beam is formed by leaving a portion of said at least one damping plate unbonded to at least one of said first brake pad backing plate and said second brake pad backing plate.

16. A drum brake assembly comprising:
at least one brake shoe;
a drum brake backplate mounted with respect to said shoe; and
at least one tuned mass damper mounted with respect to said drum brake backplate and operable to damp vibrations occasioned by said backplate, wherein said at least one tuned mass damper is placed substantially at a point of maximum amplitude for a given mode of vibration of said drum brake backplate.

17. The drum brake assembly of claim 16, wherein said at least one tuned mass damper is comprised of a mass affixed to a viscoelastic element.

18. The drum brake assembly of claim 17, wherein said at least one tuned mass damper further comprises a secondary tuned mass damper having a secondary mass affixed to a secondary viscoelastic element which in turn is affixed to said at least one tuned mass damper to form a dual mode tuned mass damper.

19. The drum brake assembly of claim 16, wherein said at least one tuned mass damper comprises at least one beam affixed with respect to said backplate, and operable to damp the vibrational kinetic energy occasioned by said backplate.

20. The drum brake assembly of claim 16, wherein said at least one tuned mass damper comprises at least one beam formed from a constrained layer viscoelastic laminate material, having at least two constraining layers and at least one viscoelastic layer disposed therebetween, and affixed with respect to said drum brake backplate, and operable to damp the kinetic energy occasioned by said backplate.
